(19) United States
(12) Patent Application Publication
(10) Pub. No.: US 2010/0235758 A1
(43) Pub. Date: Sep. 16, 2010

(54) Method, System and Apparatus for Sorting Topics within a Group

(75) Inventor: Shaofeng Shen, Hangzhou (CN)

Correspondence Address: LEE & HAYES, PLLC, 601 W. RIVERSIDE AVENUE, SUITE 1400, SPOKANE, WA, 99201, US

(73) Assignee: ALIBABA GROUP HOLDING LIMITED, Grand Cayman (KY)

(21) Appl. No.: 12/160,595

(22) PCT Filed: Jul. 10, 2008
(86) PCT No.: PCT/US2008/069674

§ 371 Date: Dec. 15, 2009

(30) Foreign Application Priority Data
Jul. 13, 2007 (CN) 200710130205.1

(51) Int. Cl. G06F 15/16; G06F 3/01

(52) U.S. Cl. 715/752; 709/206

(57) ABSTRACT

A method for sorting topics in a user group of instant messaging is disclosed. An instant messaging server receives a user request for creating a topic within a user group, and thereupon creates a corresponding topic group. Upon subsequently receiving from a request for joining the topic, the server adds the requesting user into the corresponding topic group. Upon receiving a message sent from a user of the topic group, the server transmits the message to other users of the same topic group. Using the topic sorting technology in group chatting, the method allows messages to be conveniently categorized for better use by the user, thus reducing the interference from unrelated topics while allowing group discussions. The method helps to improve user experience and maximize the benefit of group chatting, and may also reduce the volume of unnecessary messages sent by the server.

### RELATED APPLICATIONS

This application is a national stage application of international patent application PCT/US08/69674, filed Jul. 10, 2008, claiming priority from Chinese patent application, Application No. 200710130205.1, filed Jul. 13, 2007, entitled “METHOD, SYSTEM AND APPARATUS FOR SORTING TOPICS WITHIN A GROUP”.

### BACKGROUND

Instant messaging (IM) is a form of real-time communication between two or more people by conveying information via computers connected over a network such as the Internet. Instant messaging has become widely used for online communication such as online chatting. Some examples of popular instant messaging software in China are TaoBao, QQ, MSN, POPO, UC and LAVA-LAVA. Using instant messaging, one can check if a friend is online, and instantly communicate with the friend. Instant messaging requires less time than sending electronic mails, and is more convenient than dialing for a phone call. For many, instant messaging is the most convenient way of communication in the age of networking.

Instant messaging is a terminal service. It allows two or more than two persons instantly sending text messages and files with one another through the network. Instant messaging also permits voice and video communication over the network. Most of the instant messaging services have a property of presence awareness, such as displaying a contact list and showing whether the contacts on the list are online for chatting at the time. Instant messaging provides real-time communication that allows users to build up their personal chat rooms within the network. As networking becomes more popular, IM software has become an important tool of maintaining interpersonal relationships for many people. Many people have even now put their IM accounts (e.g., QQ accounts and MSN accounts) on their name cards, adding important means of contact other than an address and phone numbers.

Most of the existing instant messaging software provides a group function. For example, the group function of TaoBao and QQ is to broadcast the messages to all members within the same group. A group is a fixed relationship created in the server. The message within the group is first transmitted from a user to the server and then from the server to all members in the same group according to the relationship setting of the group. The group function (or group chatting function) has become widely used by the IM users. However, many problems exist in the use of conventional group chatting function. For instance, it can be very chaotic to have a group discussion, often because the contents of the discussions in the group are not managed under any rules, making it difficult to locate or filter them. If users cannot find a topic of interest, they cannot effectively participate in discussions in the group. As a result, many users, having received contents of uninteresting topics, cannot effectively participate in the discussion using instant messaging.

In order to resolve the aforementioned defects, existing technologies provide private chatting within a group. Private chatting is a temporary relationship created in the server. Private chatting allows messages to be sent to a more restricted circle of parties through the server. During private chatting, there is no interference from uninteresting topics.

However, certain problems still exist in the existing technologies using private chatting. For instance, private chatting in existing technologies is restricted to a two-person mode (chatting between two users only). This limits group participation and defeats the original purpose of the group chatting function. Poor user experience often diminishes the benefits of group chatting.

### SUMMARY

Disclosed are a method and a system for sorting topics in a group to solve the problem of interference in group chatting. According to the method, an instant messaging server receives from an initiating user a request for creating a topic within a user group, and creates a corresponding topic group. Upon subsequently receiving from a requesting user a request for joining the topic, the server adds the requesting user into the corresponding topic group. Upon receiving a message sent from a participating user of the topic group, the server transmits the message to other users of the same topic group through the instant messaging server. To notify the users within the same user group about the created topic, the server may send a notification message to the users or post an announcement in the primary space of the user group. To allow instant messaging in the created topic, the server adds a topic window in the user interface of users who have joined the topic group.

In one embodiment, the instant messaging server manages the topic group on a temporary and dynamic basis. For example, the server deletes a user from the topic group when the user withdraws from the topic group. After deleting the user who has withdrawn from the topic group, the server may further determine the number of users in the topic group, and delete a topic if the number of user in the topic group has become zero.

The system for sorting topics includes a server connected to a user terminal. The user terminal is used for communicating to the server user requests for creating a topic, requests for joining a topic and requests for withdrawing from a topic, while the server manages the topic group according to the requests received from the user terminal. Specifically, the server is adapted to receive from an initiating user a user request for creating a topic within a user group; create the topic and a corresponding topic group within the user group; receive from a requesting user a user request for joining the topic; add the requesting user into the corresponding topic group; receive from a participating user in the topic group a message related to the topic; and transmit the message to users of the topic group.

In one embodiment, the server includes a topic creation module, a topic group processing module and a message transmission module. The topic creation module is used to receive the user request for creating the topic and to create the topic group within the user group; the topic group processing module is used to receive the request for joining the topic and to add the requesting user into the topic group; and the message transmission module is used to receive a message from a participating user and to send the message to users of the topic group.

The server may further include a notification module used to notify users in the user group about the topic created. The notification module may include a message notification sub-module to send a notification message to the users in the group, and/or an announcement sub-module to post an announcement in the primary space of the user group about the topic created.

The topic group processing module is also used to delete a user from the topic group after the user withdraws from the topic. The topic group processing module may include a topic deletion sub-module to determine the number of users in the topic group and delete the topic if the number of users of the topic group is zero.

In one embodiment, the server is adapted to communicate to a display module of a user terminal to add a topic window to a user interface of the requesting user and to display messages of the topic in the topic window. The display module is adapted to display the added topic window in the user interface of a user who has joined the topic group. The display module displays the messages of the topic in the topic window.

Using the topic sorting technology in group chatting, the method described herein allows messages to be conveniently sorted by the user, thus reducing the interference from unrelated topics while allowing group discussions. The method helps to improve user experience and maximize the benefit of group chatting, and may also reduce the volume of unnecessary messages sent by the server.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. The use of the same reference numbers in different figures indicates similar or identical items.

FIG. 1 is a structural diagram of an exemplary system that provides topic sorting in a user group in instant messaging.

FIG. 2 shows a flow chart of an exemplary method for sorting topics.

FIG. 3 shows a flow chart of another exemplary method for sorting topics.

FIG. 4 shows an exemplary environment for implementing the method of the present disclosure.

### DETAILED DESCRIPTION

The exemplary embodiments disclosed herein introduce a topic function in group chatting to reduce interference among unrelated topics. Topic groups are established within a user group, which can be a conventional user group such as a chat group set up by an instant messaging server. The topic function allows users to choose their topics of interest and participate in a corresponding discussion. As such, user satisfaction is increased. The topic function proposed by the exemplary embodiments disclosed herein is a temporary relationship setting. The instant messaging server updates and maintains users who join the topic and users who withdraw from the topic in real time. The server also timely updates the status of the topic in the primary space of the user group so the users can choose their topics of interest for participation.

Exemplary embodiments of practical implementations are described in further details below with reference to several figures.

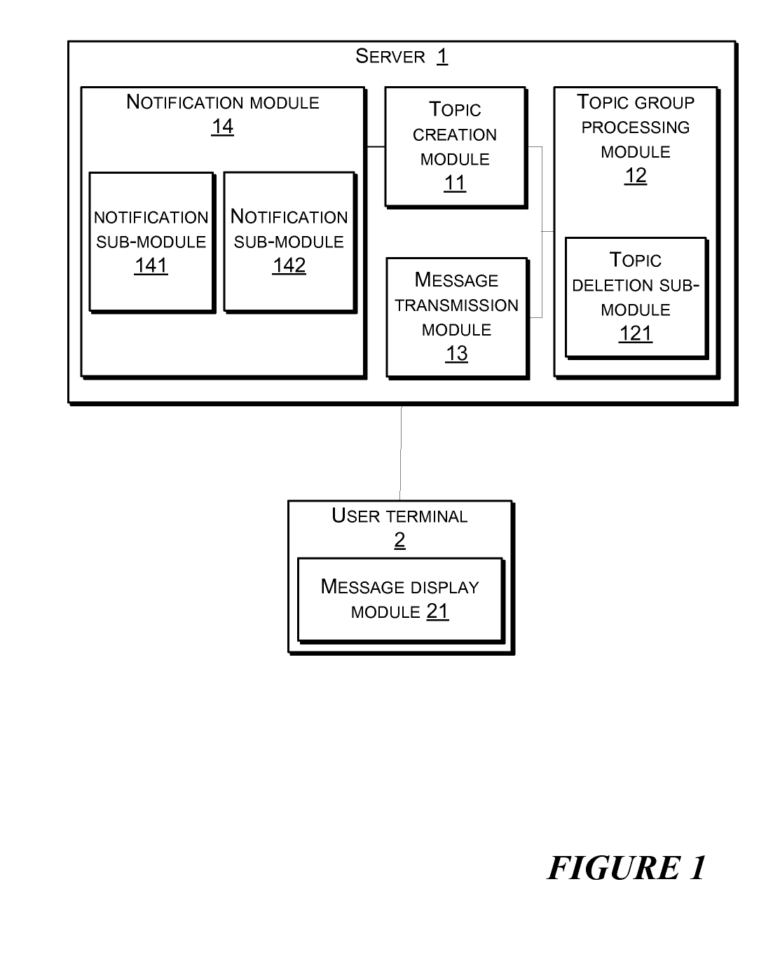

FIG. 1 is a structural diagram of an exemplary system that provides topic sorting in a user group in instant messaging. The system in FIG. 1 is based on an instant messaging server 1, which is connected to and user terminal 2. The user terminal 2 is representative of multiple user terminals that may be connected to the server 1. Multiple users (not shown) may access the instant messaging system hosted on server 1 through multiple user terminals 2. The instant messaging system may have multiple user groups each consisting of a group of users. Such user groups may be conventional instant messaging groups such as news groups and chat groups. Each user group has a primary space presented to a user through user terminal 2 when the user logs on the instant messaging system hosted on the server 1 and enters the user group. The primary space typically displays relevant information of the corresponding user group.

Through the user terminal 2, a user sends requests to the server 1, such as a request for creating a topic, a request for joining a topic and a request for withdrawing from a topic. The server 1 is used to manage topic groups according to the requests received from the user terminal 2.

The server 1 includes a topic creation module 11, a topic group processing module 12 and a message transmission module 13. The topic creation module 11 is used to receive from an initiating user a request for creating a topic from the user terminal 2 and create a corresponding topic according to the request. The request for creating a topic may include information such as the theme (or title) of the topic. Upon receiving the request and its information, the server 1 creates a corresponding theme and notifies other users in the same user group about the created topic.

For example, the server 1 may provide a button in the primary space of the user group for the initiating user to click to create a topic in the user group and enter a corresponding theme. The server 1 then displays the created topic in a designated area in the primary space for users in the user group to choose. After the created topic is displayed, users in the same user group can see the status of the topic.

The topic group processing 12 is used to receive from a requesting user a request for joining a topic and add the requesting user to the corresponding topic. For instance, the requesting user may choose a topic of interest displayed in the designated area in the user interface of the primary space of the user group. The topic selection may be accomplished using a user pointer device such as a mouse (e.g., by double-clicking on a topic of interest).

Once the requesting user has joined the topic, the user interface window for the user is divided into two parts: one for the content of primary space of the user group and the other for the content of the topic. The user can also choose more than one topic of interest for participation at the same time. Each time the user joins a topic, a space is segmented from the message window to be used as the new topic message window. The topic message window is used for both displaying the communication content (such as messages already posted) of the topic and for entering new messages by the user. The new messages entered through the topic message window are sent to the server 1, which in turn transmits the received messages to the other users of the same topic group as further illustrated below.

The message transmission module 13 is used to receive messages sent by the users in the topic group and transmit these messages to other users within the same topic group. For example, suppose user A belongs to a user group which also has other users such as user C and user D. User A creates a topic concerning car maintenance in the group. Immediately after the topic has been created, the corresponding topic group has only user A as its member. Upon seeing the topic through the user interface of the primary space of the user group, users C and D also join the topic. The server 1 updates the topic group by adding users C and D, and transmits messages sent by any current user of the topic group to other current users in the same topic group.

The server 1 also includes a notification module 14. The notification module 14 is used to notify users in the user group about the topics created, such that the users may have timely knowledge of the presence of created topics and choose topics of interest to participate. Proposed herein are two exemplary modes of notifying users in the user group.

In the first exemplary mode, the server 1 automatically posts an announcement (or notice) on the designated area of the primary space of the user group for users to choose. Once the announcement is posted, all users in the user group can see the status of the topic. For example, the created topics may be displayed in a designated area on a side (e.g. right side) of the user interface of the primary space. A user can directly double-click the topic to participate the discussion. Once a user of the user group joins the topic, the user's message window is divided into two parts: one for displaying the contents of the primary space of the user group (e.g., messages in the user group), and the other for displaying the contents of the topic. The user can also choose to participate in several topics for discussion at the same time. Each time a topic is added, a segment from the message window is used as a topic window for this topic. Theoretically, an unlimited number of topics may be joined by the same user at the same time. However, since the space for the message window is limited, it may be optimal if the server 1 sets a limit on the number of topics a user can join at a time.

In the second exemplary mode of notifying other users in the group, the server 1 automatically sends a notification message about the topic to other users in the user group after the topic is created. Within this message a link for the topic may be provided so that the users within the user group can simply double-click on the topic to enter into the discussion of the topic. Optimally, the server 1 can set a limit on the number of topic a user can join.

The notification module 14 further includes notification sub-modules 141 and 142. The notification sub-module 141 is a message notification module used to send notification messages to the users in the user group. The notification sub-module 142 is used to post an announcement in the primary space of the user group about the topic created.

In some embodiments, the server 1 manages the topic group on a temporary and dynamic basis. For instance, the topic group processing module 12 is also used to delete a user from the topic group after the user has withdrawn from the topic, as illustrated below.

Since the topic group is temporary, the server updates and maintains the topic group from time to time, and preferably in real time as users join and leave the topic group. If a user no longer wants to participate in the topic, the user can exit the topic and return to the user interface of the primary space of the user group, or participate in another topic. As the user exits the topic, the original message window is automatically restored. For instance, when the user joins a topic, the message window is divided into two parts. After the user withdraws from this topic, the message window is restored to a whole window automatically. After the user withdraws from the topic or goes offline, the server 1 automatically deletes the user from the topic group. Thereafter, the discussion contents of the topic will no longer be sent to this user.

Since a topic group is a temporary setup, a topic group that no longer has any interested user may be deleted to prevent expired topics from occupying the user interface of the primary space for extended periods of time. To accomplish this, the topic group processing module 12 further includes a topic deletion sub-module 121. The topic deletion sub-module 121 is used to determine if the number of users in a topic group is zero. If the number of users in a topic is found to be zero, the topic deletion sub-module may delete the topic. According to an exemplary method of determination for deletion, the number of users in the topic group is checked each time after a user withdraws from the topic or goes offline. As such, a topic without any user participation can be cleared promptly.

The user terminal 2 includes a message display module 21. The message display module 21 is used to display a topic window which is added to the user interface of the user when the user joins a topic. The message display module 21 also displays the messages in the topic group in the topic window. Specifically, after the user double-clicks on the topic, the message window of the user is divided into two parts: one for displaying the contents of the primary space (e.g., the messages in the user group), and the other is a topic window for displaying the contents of the topic. If the user joins multiple topics, the message display module 21 also display and manage multiple topic windows of the user.

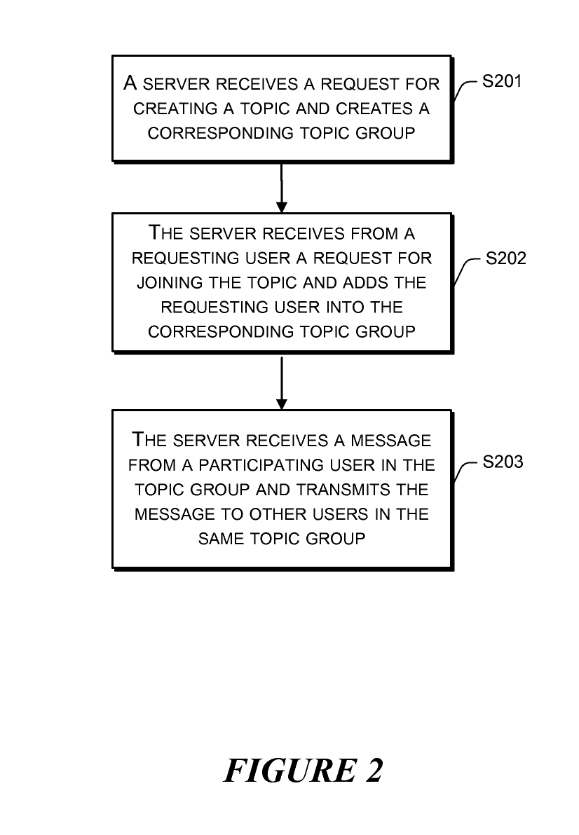

FIG. 2 shows a flow chart of an exemplary method for sorting topics. In this description, the order in which a process is described is not intended to be construed as a limitation, and any number of the described process blocks may be combined in any order to implement the method, or an alternate method. With the illustrated exemplary method to set up topics, the server can reduce the interference among the users in a user group while maintaining group discussion.

Block S201: Server 1 receives from an initiating user a request for creating a topic and creates the topic and a corresponding topic group in the user group according to the request. The request for creating a topic may include the information such as the theme of the topic. Upon receiving this information, the server 1 creates a corresponding theme in the user group and notifies other users in the user group about the topic of the theme. Other users can then join this topic if they are interested. For example, the server 1 may provide a button in the primary space of the user group. An initiating user can click on the button to create a topic in the user group and enter a corresponding theme of the topic. The server then displays the created topic in a designated area in the primary space for users in the same user group to choose. Once the topic is created and displayed, users in the same User group can see the status of the topic. It should be noted that the topic group created by the server is a temporary setting. The server 1 may update the topic group and in time, and preferably in real time as users join and leave the topic group. For example, suppose user A creates a topic concerning car maintenance in the group. Immediately after the topic group is created, the topic group has user A as its only member. The membership of the topic group, however, will change in time depending on user participation.

Block S202: The server 1 receives from a requesting user a request for joining the topic and adds the requesting user into the corresponding topic group. In general, the requesting user and the initiating user are in the same user group. For instance, a user in the same user group may double-click on the topic displayed in the designated area in the user interface of the primary space of the user group. The user can choose to join any topic of interest. Once the user has joined a selected topic, the user interface window for the user is divided into two parts: one for displaying the content of primary space of the user group and the other for displaying the content of the selected topic. User may choose more than one topic of interest for participation at the same time. Each time the user joins a topic, a segment is allocated from message window as the topic message window of the new topic. As further shown in block S203 below, the topic message window is used to both display the communication content of the topic and to receive topic messages entered by the user. The received topic messages are in turn delivered by server 1 to the other users of the same topic group.

The membership of the topic group changes from time to time. For example, suppose user A created a topic of car maintenance in S201. Upon seeing the topic in the user interface of the primary space of the user group, users C and D of the same user group decide to join this topic. The server 1 adds users C and D into the topic group which initially had user A as the only member. Upon adding users C and D, the topic group has three members: user A, user C and user D.

S203: The server 1 receives a message sent by a participating user in the topic group and transmits the message to the other users in the same topic group. In the example of car maintenance topic shown above, for instance, a message sent by the user A in the topic is transmitted to the users C and D through the server 1. Likewise, a message sent by the user C in the topic is transmitted to the users A and D through the server 1.

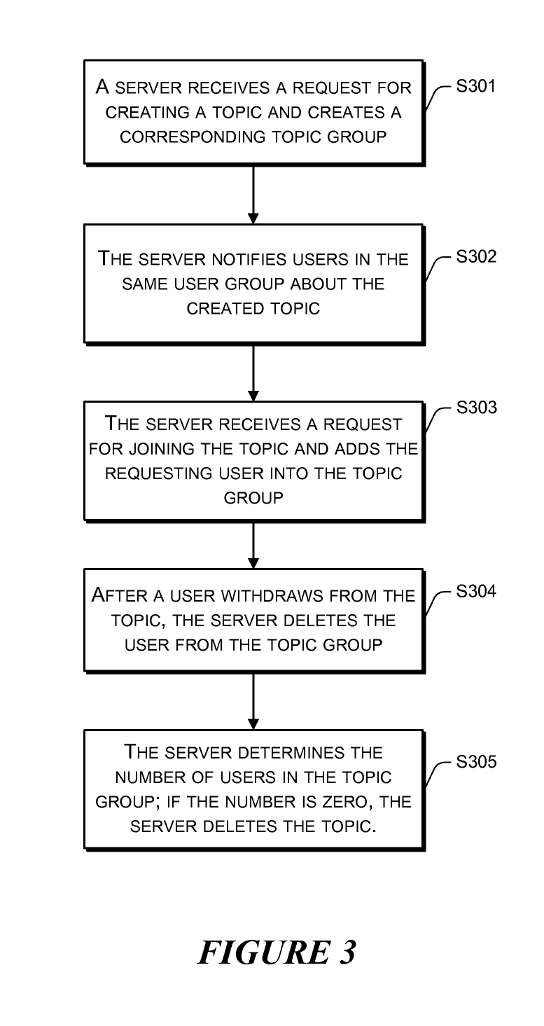

FIG. 3 shows a flow chart of another exemplary method for sorting topics. Compared with the exemplary method shown in FIG. 2, this exemplary method illustrates the steps for maintaining and updating the topics in real time, including steps to delete expired topics promptly. The exemplary method is described in details as follows.

Block S301: Server 1 receives from an initiating user a request for creating a topic and subsequently creates the requested topic and a corresponding topic group in the user group. The request for creating a topic may include such information as the theme of the topic. Upon receiving this information, the server 1 creates a topic of the requested theme and a corresponding topic group in the user group and notifies other users in the user group about the topic. Other users can then join this topic if they are interested. The topic group created by the server 1 is a temporary setting and the server may update the topic group in real time.

Block S302: The server notifies users in the same user group about the topic created so that the users in the same user group promptly become aware of the presence of the created topic and choose to participate if interested. Two different exemplary modes of notifying users in the group may be used. In the first mode, the server automatically posts an announcement on the designated area of the primary space of the user group for user to choose. Once the announcement is posted, users in the same user group can see the status of the topic. For example, the created topic may be displayed in a designated area on a side (e.g. right side) of the user interface of the primary space. Users can directly double-click the topic to participate in the discussion of the topic. Once a user of the user group joins the topic, the user's message window is divided into two parts: one for displaying the contents of the primary space of the user group (e.g., messages in the user group), and the other for displaying the contents of the topic. The user may participate in multiple topics for discussion. Each time a topic is added, a segment of the message window is used for this topic.

According to a second exemplary mode of notifying other users in the user group, after the initiating user has created the topic, server 1 automatically sends a notification message about the created topic to other users in the user group. Within the message a link for this topic may be provided so that a user within the user group can simply double-click on the topic to enter the discussion of the topic. Optimally, the server may set a limit on the number of topic a user can join at one time.

It is appreciated that how to notify users in the group is not the focus of the present disclosure. The server 1 can use many different ways to notify the users in the group. The above-described two methods are just examples of the method for notifying users. Any suitable methods of notifying users in the group adopted by the server are still within the boundary of the method disclosed herein.

Block S303: The server 1 receives a request for joining the topic and adds the requesting user into the topic group. The user terminal 2 of the requesting user adds a new topic window to the user interface and displays the current messages of the topic in the topic window. For example, once the requesting user has joined the topic, the user interface window for the requesting user is divided into two parts: one for the content of primary space of the user group and the other for the content of the topic. A user can choose to participate in more than one topic of interest at the same time. Each time the user joins a topic, a segment of the message window is used for a new topic message window. The topic message window is used to display the communication content of the topic, but is also used to receive messages entered by the user.

S304: After a user quits from the topic, the user is deleted from the topic group. The server may update and maintain the topic group on a temporary or dynamic basis, for example in real time. If a user who has previously joined the topic group no longer wants to participate in a certain topic, the user can exit the topic and return to the user interface of the primary space of the user group, or participate in another topic. Upon the exit of the user, the original message window is restored. For instance, when the user joins a topic, the message window is divided into two parts. After the user withdraws from this topic, the message window is then restored to a whole window automatically. After the user withdraws from the topic or goes offline, the server automatically deletes the user from the topic group. Thereafter, the discussion contents of the topic will no longer be sent to this user. Using the car maintenance topic discussed above as an example, if user C quits from the topic or goes offline, the server may delete user C from the topic group. Thereafter, messages sent by the remaining members of the topic group (e.g., users A and D) will no longer be sent to user C.

S305: After a user withdraws from the topic or goes offline, the number of users remaining in the topic group is checked. If the number of users in a topic is found to be zero, the topic is deleted. Having no user in a topic group indicates that no one is interested in this topic anymore. Since topic group is a temporary relationship setting, the server 1 preferably should delete this topic promptly to prevent expired topics from occupying the user interface of the primary space for a long time.

### Implementation Environment

The above-described techniques may be implemented with the help of a computing device, such as a server or a personal computer (PC) having a computing unit.

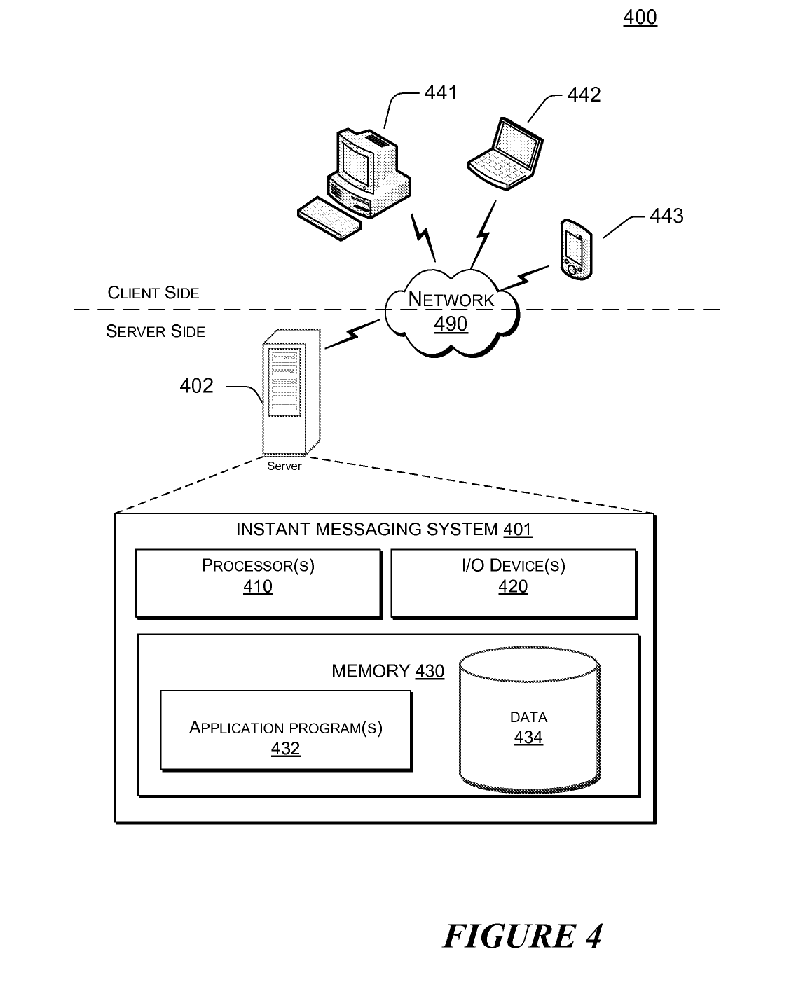

FIG. 4 shows an exemplary environment for implementing the method of the present disclosure. In illustrated system 400, some components reside on a client side and other components reside on a server side. However, these components may reside in multiple other locations. Furthermore, two or more of the illustrated components may combine to form a single component at a single location.

Instant messaging system 401 is implemented with a computing device 402 which is preferably a server and includes processor(s) 410, I/O devices 420, computer readable media (e.g., memory) 430, and network interface (not shown). Other computing devices such as 441, 442 and 443 may have similar components. The computer device 402 is connected to computing devices 441, 442 and 443 through network(s) 490. In one embodiment, computing device 402 is an instant messaging server described herein, while computing devices 441, 442 and 443 may each be used as a user terminal as described herein.

The computer readable media 430 stores application program modules 432 and data 434 (such as using information, group information and messages). Application program modules 432 contain instructions which, when executed by processor(s) 410, cause the processor(s) 410 to perform actions of a process described herein (e.g., certain actions in the processes of FIGS. 2-3).

It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing device may be any device that has a processor, an I/O device and a memory (either an internal memory or an external memory), and is not limited to a personal computer. Especially, computer device 402 may be a server computer, or a cluster of such server computers, connected through network(s) 490, which may either be Internet or an intranet.

As illustrated above, because the disclosed method and system use topic sorting technology in group chatting, topics and the associated user messages are conveniently sorted to be better handled by the user. This can reduce the interference from unrelated topics while allowing group discussion. Therefore, the method and the system described herein help to improve user experience and maximum the benefit of group chatting. To a certain extent, the method also reduces the volume of unnecessary messages sent by the server.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method of sorting topics using an instant messaging server, the method comprising:
receiving from an initiating user a user request for creating a topic within a user group;
creating the topic and a corresponding topic group in the user group;
receiving from a requesting user a user request for joining the topic;
adding the requesting user into the corresponding topic group;
receiving from a participating user in the topic group a message related to the topic; and
transmitting the message to users of the topic group.

2. The method as recited in claim 1, further comprising:
upon creating the topic in the user group, notifying users within the user group about the topic created.

3. The method as recited in claim 2, wherein the notifying users within the user group about the created topic comprises:
sending a notification message to the users within the user group or posting an announcement in a primary space of the user group.

4. The method as recited in claim 1, further comprising:
deleting the requesting user from the topic group upon receiving from the requesting user a request for withdrawal from the topic group.

5. The method as recited in claim 1, further comprising:
deleting the topic if the number of users in the topic group is zero.

6. The method as recited in claim 1, wherein upon creating the topic in the user group, the method further comprises:
adding a topic window to a user interface of the requesting user; and
displaying messages of the topic in the topic window.

7. An instant messaging system comprising a server connected to user terminals, wherein the server is adapted to perform the following:
receiving from an initiating user a user request for creating a topic within a user group;
creating the topic and a corresponding topic group within the user group;
receiving from a requesting user a user request for joining the topic;
adding the requesting user into the corresponding topic group;
receiving from a participating user in the topic group a message related to the topic; and
transmitting the message to users of the topic group.

8. The system as recited in claim 7, wherein the server includes:
a topic creation module to receive the user request for creating the topic and to create the topic group within the user group;
a topic group processing module to receive the request for joining the topic and to add the requesting user into the topic group; and
a message transmission module to receive the message from the participating user and to send the message to users of the topic group.

9. The system as recited in claim 8, wherein the topic group processing module is further used to delete the requesting user from the topic group after the requesting user withdraws from the topic.

10. The system as recited in claim 8, wherein the topic group processing module further includes a topic deletion sub-module used to delete the topic if the number of users in the corresponding topic group is zero.

11. The system as recited in claim 7, wherein the server is adapted to further notify users in the user group about the topic created.

12. The system as recited in claim 7, wherein the server includes a notification module to send a notification message about the created topic to users in the user group.

13. The system as recited in claim 7, wherein the server includes a notification module to post in a primary space of the user group an announcement about the created topic.

14. The system as recited in claim 7, wherein the server is adapted to communicate to a display module of one of the user terminals to add a topic window to a user interface of the requesting user and to display messages of the topic in the topic window.

15. An instant messaging server comprising:
a topic creation module to create a topic group within a user group according a user request;
a topic group processing module used to receive from a requesting user a request for joining the topic group and to add the requesting user into the topic group; and
a message transmission module used to receive a message from a participating user and to send the message to users within the topic group.

16. The server as recited in claim 15, further comprising:
a notification module used for notifying users in the user group about the topic created.

17. The server as recited in claim 16, wherein the notification module includes a notification sub-module used to send a notification message to the users in the user group.

18. The server as recited in claim 16, wherein the notification module includes an announcement sub-module used to post an announcement about the created topic in a primary space of the user group.

19. The server as recited in claim 15, wherein the topic group processing module is used to delete the requesting user from the topic group after the requesting user withdraws from the topic.

20. The server as recited in claim 15, wherein the topic group processing module includes a topic deletion sub-module used to delete the topic if the number of users of the topic group is zero.
